(19) United States
(12) Patent Application Publication
(10) Pub. No.: US 2022/0009025 A1
(43) Pub. Date: Jan. 13, 2022

(54) Laser Augmented Drill Bit

(71) Applicant: Laser Augmented Diamond Drilling, LLC, Muskegon, MI (US)

(72) Inventor: John A. PATTEN, Muskegon, MI (US)

(21) Appl. No.: 16/926,118

(22) Filed: Jul. 10, 2020

(51) Int. Cl. B23K 26/00; B23K 26/382; B23B 51/08; B23K 26/064

(52) U.S. Cl. CPC B23K 26/0093; B23K 26/382; B23B 2251/241; B23K 26/064; B23B 51/08

(57) ABSTRACT

Disclosed is a system for working on a workpiece. The system may include a driver and selected tool. The tool may form a portion of a system that augments the tool in operating or performing hole making on a selected workpiece. The tool may include a plurality of portions and/or characteristics to work on the workpiece.

### FIELD

The subject disclosure relates to operating a tool relative to a workpiece, and particularly to an augmented tool.

### BACKGROUND

This section provides background information related to the present disclosure which is not necessarily prior art.

A work system or assembly is used to work on a workpiece, such as machine or drill a workpiece. The work system may include a machining apparatus or tool driving apparatus that has a driver portion to drive a tool. The driver portion may be an electric motor, a pneumatic motor, or other appropriate power driven system to power a tool. The tool may perform an operation on a selected workpiece.

### SUMMARY

This section provides a general summary of the disclosure, and is not a comprehensive disclosure of its full scope or all of its features.

A tool is disclosed to form or drill a hole in a workpiece. The tool may be powered with a selected driver in or with a work system. The driver may be operated in a selected manner to operate or drive the tool. The tool may be used to perform work or a work function on a selected workpiece. The work system may also be referred to as or include a machining apparatus, machine tool, etc., and generally accommodates rotating the tool and translating (axially) the tool relative to the workpiece to generate a volume of material removal to form a hole.

The driver may be powered in one or more appropriate manners, such as electrical power, pneumatic power, or other appropriate power mechanisms or combinations thereof. Accordingly, the drive mechanism may be operated and powered to move a tool. The tool may be rotated, such as for drilling. In various embodiments, the tool may include a drill bit that has a working tip and a shaft that may engage the driver. The drive may be a part of the work system that may control or power axial and rotational movement of the tool. Further, the tool may be driven with a hand-held tool, robotics system, etc.

The tool includes an elongated bore extending through the tool. The elongated bore may be a continuous bore from a first end, such as a first terminal end, to a second end, such as a second terminal end. The bore may be continuous, but formed or shaped in any appropriate shape such as straight, curved, angled, etc. The bore, alone or in combinations with additional materials, operates as a guide for a selected beam or energy, such as a laser beam to transmit through the tool to a working end. At the working end may be one or more objects, such as a lensing object that includes a selected material that is substantially transparent to the beam or energy transmitted through the bore. Thus, for example, the laser beam may interact with the workpiece and the lensing object alone or in combination with other portions of the tool may work on the workpiece, such as drill a hole.

In various embodiments the bore may be filled with a selected material and/or have an internal wall lined with a selected material. The bore may be formed as or to include a guide portion, e.g. a waveguide or optical fiber, which may be a hollow core or solid and/or coated bore, through the tool shaft. The tool shaft, therefore, may guide a selected energy or emission, such as a laser energy, through the bore to the lensing object, e.g. a diamond drill bit that may be formed as a tip of the tool.

In use, the lensing object may assist in directing and focusing the energy provided to the lensing object. The lensing object may include a selected material, such as a diamond or diamond like substance. The lensing object may assist in directing (e.g. reflecting and refracting) the energy, such as a laser energy, provided through the bore to a workpiece during an operation of the tool.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a working station assembly, according to various embodiments;

FIG. 2 is a perspective view of an assembled tool, according to various embodiments;

FIG. 3 is a plan end view of the tool of FIG. 2;

FIG. 4 is an exploded view of the tool of FIG. 2;

FIG. 5 is a perspective view of a shaft of the tool, according to various embodiments;

FIG. 6 is a plan view of the shaft of FIG. 5;

FIG. 7A is a cross-sectional view of a tool taken along lines 7A-7A, according to various embodiments;

FIG. 7B is a cross-sectional view of a tool taken along lines 7B-7B, according to various embodiments;

FIG. 8A is a top plan view of a lensing object, according to various embodiments;

FIG. 8B is a side plan view of a lensing object, according to various embodiments;

FIG. 9 is a detailed environmental view of a working end a tool, according to various embodiments;

FIG. 10 is an end plan view of a tool having a plurality of bores therethrough and a lensing object, according to various embodiments; and

FIG. 11 is a detail perspective view of a tool having a twist and curved bore therethrough and a lensing object, according to various embodiments.

Corresponding reference numerals indicate corresponding parts throughout the several views of the drawings.

### DETAILED DESCRIPTION

Example embodiments will now be described more fully with reference to the accompanying drawings.

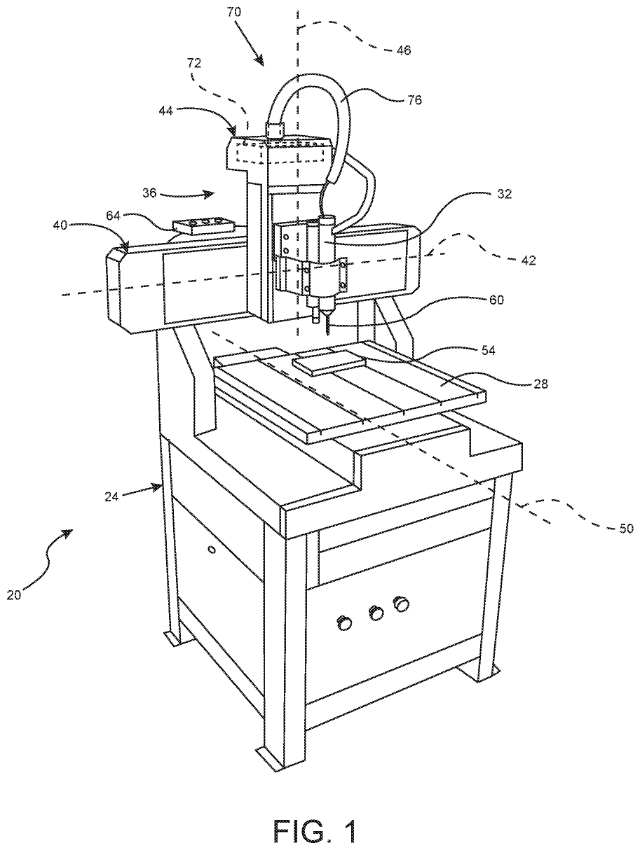

With initial reference to FIG. 1, a work assembly 20 is illustrated. In various embodiments, the work assembly may include and be referred to as a drill assembly (e.g. drill press) 20. The work assembly 20 is understood, however, to be any appropriate assembly, and is illustrated as a drill assembly for the current discussion as an example of a driver that may power or move a tool. In various embodiments, for example, the drive or assembly may be a router, a milling system, or other appropriate driving system.

The drill assembly 20 may include various components such as a support or table 24, a work surface 28, and a driver motor 32. Various components may allow for movement of the driver motor 32 relative to the work surface 28, such as a trolley or moving system 36. The move system 36 may include a rail 40 that allows for translation along a first axis 42 and a drive or movement system 44 that allows for movement along a second axis 46. The two axes 42, 46 may be substantially orthogonal to one another and allow for movement in at least two dimensions. Further, the work surface 28 may move along a third axis 50. This may allow for substantially three dimensional positioning a tool 60 connected to the driver relative to a workpiece 54. It is understood that other degrees of freedom may also be provided of the tool 60 relative to the workpiece 54.

The drill assembly 20 may include the driver 32 that powers or moves the tool 60. The tool 60, as discussed further herein, may include various features that allow for appropriate or selected working on the workpiece 54. The tool 60 may be moved relative to the workpiece 54 in any of the three axes 42, 46, 50 to achieve a select position and/or depth of a hole or bore formed in a workpiece 54.

The drill assembly 20 may include a power or control system 64 to power the motor 32 to power or move the tool 60. The control system 64 may be used to control movement speed, rotation speed, or other features of the drill driver 32. The control 64 may also control other features, as discussed herein. The control 64 may have an input portion (e.g. buttons, touchscreen, etc.) to allow for input or receiving input from a user.

In addition to driving the tool 60, the drill assembly 20 may include a laser generation and/or transmission system 70. The laser system 70 may include a laser emission portion 72 and/or a transmission portion. In various embodiments, an energy transmitted to and/or through the tool 60 may be laser energy. The laser generation system may include any appropriate laser system, such as all or portions of the laser system(s) disclosed in U.S. Pat. No. 8,933,366 issued Jan. 13, 2015 and/or U.S. Pat. No. 10,183,337 issued Jan. 22, 2019 incorporated herein by reference. The laser emission system 70 may be incorporated into the drill assembly 20 and/or separate therefrom. The laser generated in the laser emission portion 72 may be transmitted via a laser transmission assembly 76, such as a fiber optic cable. The laser transmission system 76 may transmit the laser energy to the tool 60, such as to and/or through the tool 60. As discussed further herein, the laser emission may be directed and/or focused by the tool 60 for operation on a workpiece 54 such as one or more optical elements 77, including one or more lenses, optical splitters, anti-reflective coating(s), etc.

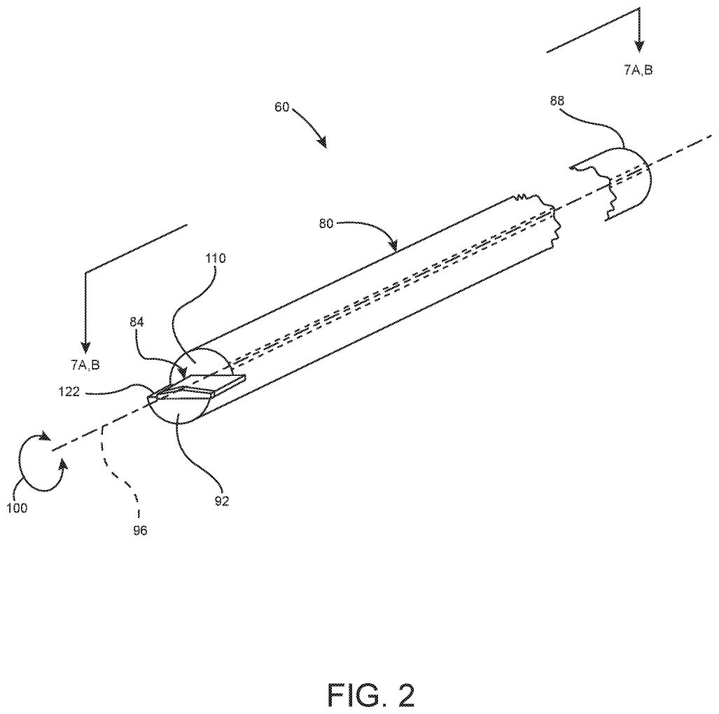

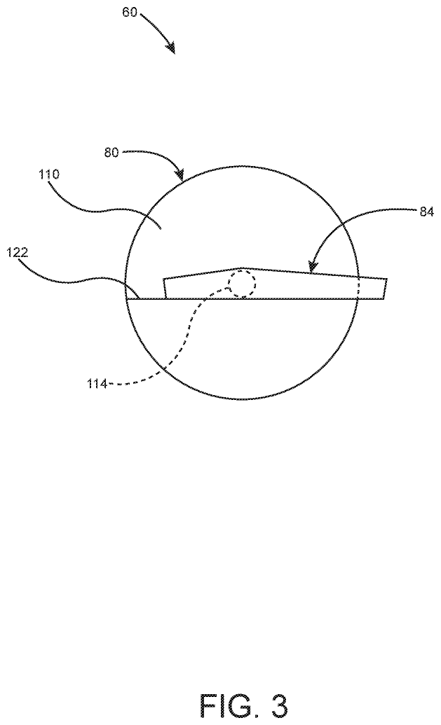

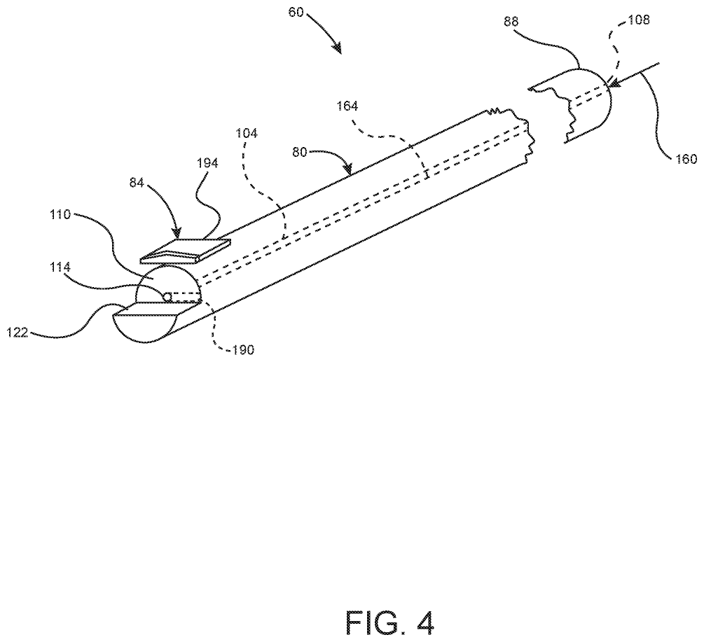

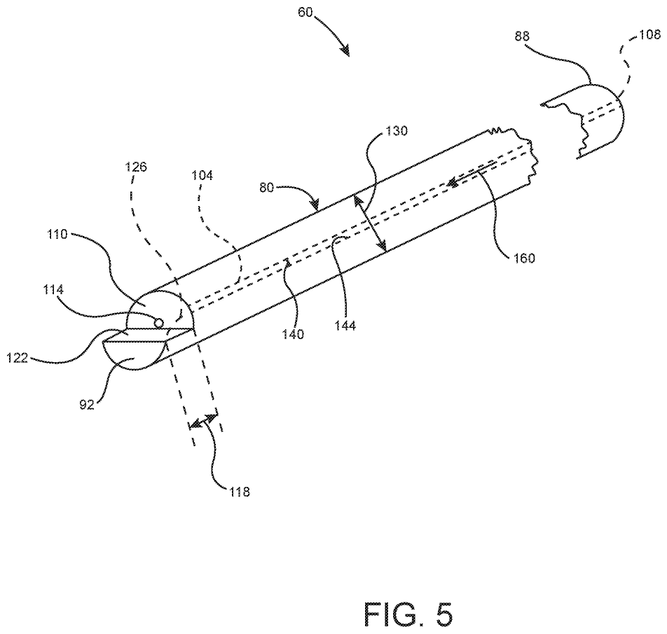

With continuing reference to FIG. 1 and additional reference to FIGS. 2-4, the tool 60 is illustrated and will be described in greater detail here. As specifically illustrated in FIG. 2 and FIG. 3, the tool 60 may include a shaft 80 and one or more lensing objects 84. The lensing object 84 may be mounted or held relative to the shaft with a selected feature, such as a holding portion or mounting surface or feature. As specifically illustrated in FIG. 4, the lensing object 84 is illustrated exploded from the shaft 80. With continuing reference to FIGS. 2-4, and additional reference to FIG. 5, the shaft 80 may be formed to allow for assembly of the lensing object 84 to a portion of the shaft 80.

The tool 60 may extend from a first terminal end 88 to a second terminal end 92. At the first terminal end 88, the shaft 80 may include any appropriate external geometry, such as a round, hexagonal, octagonal, or annular geometry to allow for engagement to the driver 32. As discussed above, the driver 32 may be a drill motor and, therefore, may impart a rotational motion to the shaft 80 by engagement with the first terminal end 88 such as via a chuck or collet. The portion of the driver to engage the shaft may include generally known chucking devices and collets. The shaft 80 may extend along an axis 96 between the first terminal end 88 and a second terminal end 92. The driver 32 may be formed and/or operated to rotate in either or both directions of double-headed arrow 100 or move the tool 60 an any appropriate direction, such as to rotate around the axis 96. Accordingly, the tool 60 may be rotated by the driver 32 around the axis 96 for working on the workpiece 54.

The shaft 80 may have a bore or passage 104 formed therein through the shaft 80. The bore 104 may extend from the first terminal end 88 from an entry bore terminal end 108 to an intermediate end or surface 110. The bore 104, therefore, may extend from the entry or inlet bore end 108 to an outlet or exit bore end 114. Thus, the bore 104 may include at least two terminal ends 108, 114. The intermediate end 110 may be formed on the shaft 80, such as by removing a volume of material from the shaft 80 to form the bore 104 in the shaft 80.

The shaft 80 may extend along the axis 96 and the bore 104 may also extend along the axis 96. Thus, the bore 104, which is formed as a transmission portion, and the shaft 80 may be substantially co-axial. It is understood, however, that the bore 104 may not be co-axial with the shaft 80. Thus, the bore 104 may be formed off-center relative to a center of the shaft 80. The lensing object 84, however, may receive energy transmitted through the bore 104, also referred to as an energy transmission portion. The lensing object 84, therefore, may be any appropriate material that is substantially transparent to the energy transmitted through the bore 104. In various embodiments, the lensing object 84 may be provided or formed as one or more portions and mounted to the shaft 80 and allow transmission of a sufficient amount of energy to assist in drilling the workpiece. Further, according to various embodiments, the lensing object 84 may be a hard and optically transparent tool material including at least one or more than one of a diamond, a sapphire, a ruby, a gem, other single crystal minerals, a poly crystalline, and/or amorphous material. Generally, the lensing object 84 is able to direct (e.g. reflect and refract) and/or transmit selected energy, such as a laser beam, and/or work on the workpiece 54, such as by drilling a hole therein.

It may be also understood that the intermediate end 110 may be a selected distance 118 from the second terminal end 92 of the shaft 80. The distance 118 may be any appropriate distance, such as a distance to accommodate the lensing object 84. As discussed herein, the lensing object 84 may be placed at the bore terminal end 114. The distance 118 may be a lensing object holding or mounting portion. The distance 118, therefore, allows for the placement or generation of a tool post or mounting ledge, which may also be referred to as a surface, 122. The post or surface 122 and the intermediate end 110 may be formed on or by the shaft 80 by removing the selected material, during formation of the shaft 80, or any other appropriate manner. Nevertheless, the intermediate end 110 and the surface 122 may be formed near the second terminal end 92 of the shaft 80. The second terminal end 114 of the bore 104, which extends through a center of the shaft 80, is generally exposed through the intermediate end 110.

Further the intermediate end 110 and the surface 122 may be formed substantially orthogonal to one another, or other appropriate angle. Accordingly, the surface 122 may be formed at an angle 126 relative to the intermediate end 110. The angle 126 may be any appropriate angle, such as about 0 degrees to about 180 degrees. The angle 126 may allow for assisting in positioning and fixing the lensing object 84 relative to the shaft 80, as discussed further herein.

The shaft 80 includes a selected dimension, such as a diameter 130 that may be appropriate for forming or drilling a hole in the workpiece 54. The diameter 130 may be any appropriate diameter, such as generally about 0.1 millimeters (mm) to about 10 centimeters (cm), including about 1 mm to about 10 mm. Generally, the diameter 130 may be selected based upon a selected size of a bore or working diameter to be formed in the workpiece 54, as is generally understood by one skilled in the art. The diameter 130, however, may have a radius centered at an axis of rotation which may also be a center of the bore 104.

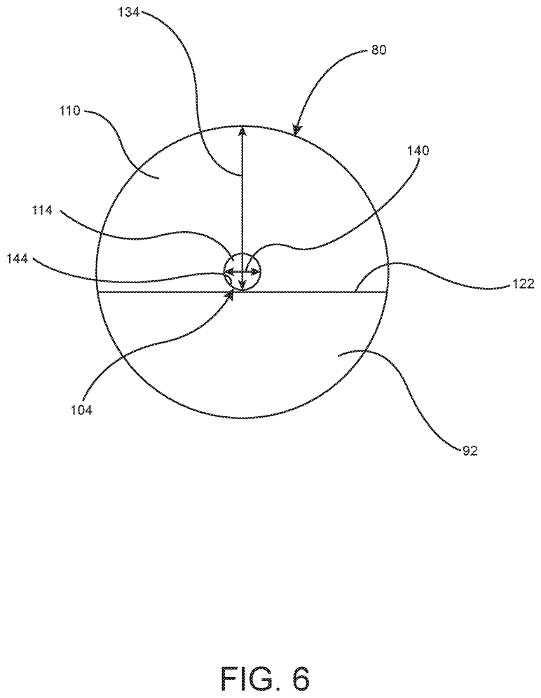

The intermediate end 110 may have a height 134 (FIG. 6) relative to the surface 122. The height 134 may allow the lensing object 84 to be positioned on the surface 122 such that the bore terminal end 114 may be covered in part or in total by the lensing object 84. The bore or terminal end 114, however, need not be entirely exposed and may be only partially exposed at the intermediate end 110.

The bore 104 may be formed in the shaft 80 in an appropriate manner. For example, the bore 104 may be drilled through the shaft 80. Alternatively, and/or in addition thereto, the shaft 80 may be formed with the bore 104, cut with a selected process, or any other appropriate formation technique. In various embodiments, in addition to and/or alternatively to those discussed above, the bore 104 may be formed by extrusion of the shaft 80. For example, the shaft 80 may be an extruded bar (e.g. of steel, carbide, etc.) and the bore 104 is formed during the extrusion. Further, the bore may be formed through a multiple formation process and may include a transparent portion therein.

In various embodiments, the bore 104 may include a diameter 140 defined by an inner wall 144 of the bore 104. The bore 104 may be formed in any appropriate shape, such as substantially cylindrical bore such that the inner wall 144 is substantially cylindrical. The bore 104 may, however, also include any selected shape or cross-section shape or area (e.g. square, rectangle, hexagonal, etc.). The inner wall 144, therefore, may be formed within the shaft 80 and define the diameter 140.

The tool shaft 80 of the tool 60 is formed of an appropriate material. Appropriate materials for the shaft 80 may include carbides, metal, and/or metal alloys. The shaft 80 may also or alternatively be formed of a material that has an appropriate toughness and rigidity to allow for working on the workpiece 54. It is understood therefore that the shaft 80 may also be formed of selected materials, such as ceramics, etc. It is further understood that the shaft 80 may be formed of more than one material. In various embodiments, the shaft 80 may be formed as separated components that are formed together or as a single piece.

Further, the shaft 80 may include a plurality of materials. For example, the shaft 80 may be formed of a metal or metal alloy. An internal member or portion may be positioned within the bore 104. An internal material may be formed of a second material. In various embodiments, for example, the bore 104 may be formed of or have positioned therein a polymer, co-polymer, amorphous material (e.g. fiber optic glass), crystalline material, or other materials. Also, material placed in the bore 104 may be formed of more than one material. Also, the material placed in the bore 104 may be formed as one piece or as separated pieces that are formed together and/or placed in the bore 104.

In various embodiments, the shaft 80 may be formed of a solid billet material, such as a selected stainless steel alloy, carbide, etc. The bore 104 may be formed therein, such as by boring or drilling the bore 104 in the shaft 80. Thereafter, a second or light guide material may be positioned within the bore 104. Thus, the tool 60 having the shaft 80 may be formed of more than one material.

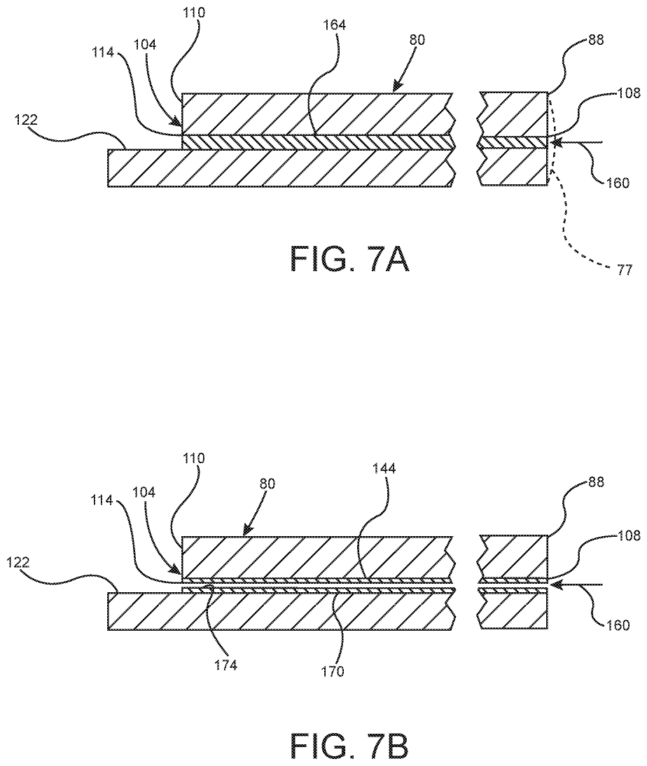

With continuing reference to FIG. 2 and additional reference to FIG. 7A, as discussed above and further herein, the bore 104 and/or the material within the bore 104 may act as a system or portion to transmit a selected emission, such as a laser beam. The transmissions system may be a light guide, an optical fiber, or waveguide, to direct a selected emission, such as a laser emission, along the bore 104 generally in the direction of arrow 160. As discussed above, the laser emission portion 72 may generate a laser emission that may be directed to the tool 60 by the transmission line 76. Accordingly, the transmission line may be incident, such as adjacent to, the first terminal end 108 of the bore 104. A selected light guide material, such as a fiber optic fiber or member 164 may be positioned within the bore 104. The fiber optic member 164 may be rigid or flexible in light of selected properties thereof. Thus, the fiber optic member may also take on a selected shape or be formed into a selected shape. The laser emission may then generally be directed in the direction of arrow 160 to pass through the bore 104 into the second terminal end 114 of the bore 104.

The transmission of the energy through the bore 104 may be assisted by a selected material, such as the fiber optic member 164. The fiber optic member 164 may be positioned within the bore 104 in any appropriate manner, such as being pushed or driven into the bore 104. The fiber optic or other light guide material 164 may, therefore, direct a selected energy generally in the direction of arrow 160 toward the second terminal end 114 of the bore 104. As discussed further herein, therefore, the energy may be laser energy and may be focused and directed by the lensing member or object 84.

With continuing reference to FIG. 2 and additional reference to FIG. 7B, the bore 104 may be coated with a selected material 170 that may be adhered to the inner wall 144. The coating 170 may allow for the inclusion of an air gap 174 within the bore 104. The coating 170 may be positioned on the inner wall 144 to extend between the first terminal end 108 and to the second terminal end 114 of the bore 104. Therefore, the bore 104 may still act as a guide or light guide generally in the direction of arrow 160 although the bore 104 is not completely filled. The air gap 174 may assist in directing light in combination with the coating 170 toward the second terminal end 114. The coating 170 may be formed of any appropriate material, such as selected polymers, adhesives, amorphous or crystalline materials, or the like, including one or more of the same. The coating 170 may generally be an appropriate coating, such as an optically reflective coating. Further, the coating 170 may be formed as a solid member and positioned (e.g. press-fit) within the bore 104 and/or formed on the internal wall 144 of the bore 104 in a selected formation process. Coatings may be made of selected materials, such as those noted above, that provide appropriate reflection of the laser energy.

In various embodiments, the bore 104 may be uncoated or unfilled. The shaft 80 may be formed of a material to act as a guide or energy transmission portion. For example, the wall 144 of the bore 104 may be formed or finished to reflect laser light in an appropriate manner to act as a guide. The unfilled bore may operate as a hollow core fiber, especially when the shaft 80 is formed of a selected material.

Thus, the bore 104, alone or with another material, may be an energy transmission portion and transmitted and/or guide selected energy, such as a laser energy, to the second terminal end 114. Thus, the laser emission portion 72 may generate a selected laser energy that is transmitted via the transmission system 76 to the first terminal end 108 of the bore 104. The bore 104, in a selected manner such as with the included light guide material 164 and/or coating 170, may direct the energy to the second terminal end 114 of the bore 104.

In various embodiments, a selected optical element 77 may be positioned at the end 88 of the shaft 80 near or at the inlet end 108 of the bore 104. In various embodiments, the optical element 77 may include a lens to focus laser energy from an initial source or an initial portion to the shaft 80 and through the bore 104 to the lensing object 84. In various embodiments, the optical element 77 may include a lens that focuses or directs (e.g. via refraction and/or reflection) laser energy from a source to the terminal inlet end 108 of the bore 104 to direct the laser energy generally in the direction of arrow 160. Further, the optical element may include one or more antireflective coatings to assist in efficiently transferring the laser beam. Also, the optical element 77 may alone be only a coating to assist in directing the laser beam.

In various embodiments, such as those discussed further herein, the optical element 77 may further include a beam splitter. A beam splitter may separate or split a single beam into two or more beams. An entry end of the beam splitter 77 is generally on a centerline of axis of rotation of the shaft 80 (i.e. coaxially located). This allows the laser that is aligned or maintains alignment during rotation of the shaft 80. In various embodiments, for example, the bore 104 may include a plurality of bores formed through the shaft 80. Thus, the optical element 77 may include a beam splitter that splits the beam of the laser into a plurality of beams to engage or be focused or directed to more than one bore 104 in the shaft 80. Accordingly, a selected optical element 77 may be positioned on the shaft 80 to assist in directing laser energy to the bore 104 in the shaft 80. The optical element 77 may be formed of appropriate materials such as crystalline or amorphous materials that may transmit, reflect or refract the laser energy to direct it to the bore 104 in the shaft 80.

The tool 60, therefore, may include the light guide portion, such as through the bore 104. As discussed above and illustrated in the various figures such as FIGS. 2, 3, and 5, the lensing object 84 may be fixed to the shaft 80 with the tool 60. The lensing object 84 may cover or obscure a majority or all of the terminal end 114 of the bore 104. Accordingly, the lensing object 84 may act as a lens or other appropriate optical element to transmit, reflect and/or refract to direct and focus the laser energy or beam directed through the bore 104 to the terminal end 114 of the bore 104.

With specific reference to FIGS. 2 and 3, the lensing object 84 may be fixed to the shaft 80 in a selected manner. For example, the lensing object 84 may be adhered or selectively fixed to one or both of the surfaces 122 and 110. The lensing object 84 may be affixed with a selected adhesive, such as selected epoxies including one or more of epoxy, two part epoxy, high temperature epoxies or other appropriate adhesive. The adhesive may include ultraviolet light curable resins. Further, various adhering or fixation processes may be performed such as soldering or brazing of the lensing object 84 to the shaft 80. For example, the lensing object 84 may be brazed to the shaft 80 such as at the post 122.

In various embodiments, the shaft 80 may include an interference shape, such as a dove tail, to physically engage the lensing object 84. For example, a trough 190 may be formed in the surface 110 and/or the surface 122 to engage a projection or rail 210 extending from a side or end of the lensing object 84. In various embodiments, for example, the lensing object may include an edge, such as the proximal edge 194 that may be physically engaged with the trough or indent 190. Therefore, the lensing object 84 may be physically engage with the shaft 80. In various embodiments, the lensing object 84, may be connected to the shaft 80 in a plurality of mechanisms, such as in both adhesion, bonding, and/or a physical connection.

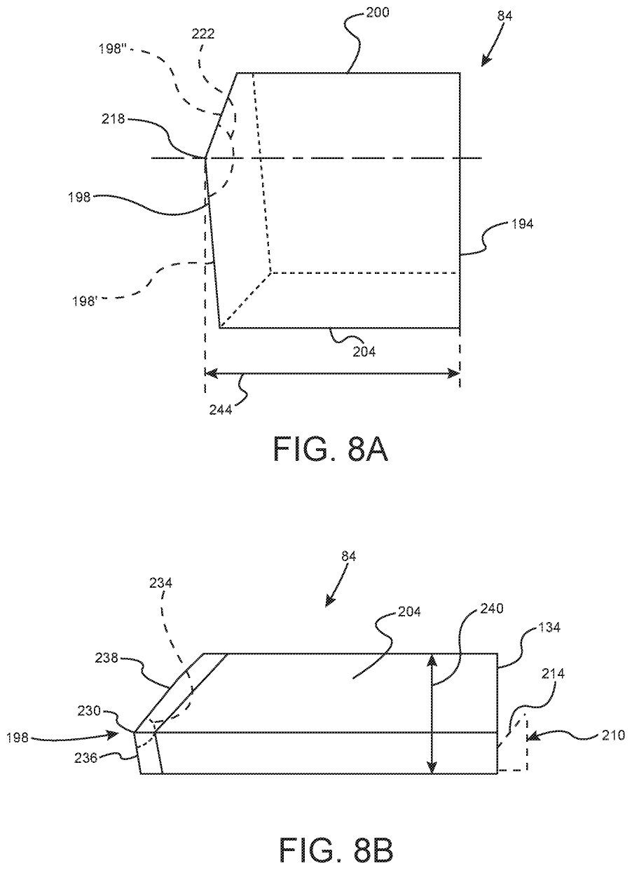

With continuing reference to FIG. 4, and additional reference to FIGS. 8A and 8B, the lensing object 84 is illustrated in detail. The lensing object 84 may include various geometries, such as a generally cuboid shape having a generally square outline shape including the proximal end 194, a distal or working end 198, and two sides 200, 204. As discussed above the proximal end 194 may include a projection or tail 210 that may include a selected geometry, such as a slanted or inclined surface 214 that may engage the trough or groove 190 to assist in holding the lensing object 84 relative to the shaft 80. The projection 210 may also assist in directing the laser beam alone or in combinations with the remainder of the lensing object 84.

Further, the lensing object 84 may include a selected geometry to assist in engaging and working on various work materials, such as the workpiece 54. Generally, the working end 198, for example, may include an apex or point 218 that may include a selected angle 222 between two edges 198′ and 198″ of the distal end 198. Further, the working end 198 may include a second peak or point 230. The second point 230 may be formed at an angle 234 between two edges or faces 236 and 238 at the working end 198.

In various embodiments the respective angles 222 and 234 may be any appropriate angle. For example, the angle 222 may be about 100 to about 170 degrees. The angle 234 may also be any appropriate angle, such as angle of about 100 degrees to about 170 degrees. The lensing object may further include additional geometries and dimensions, such as a height 240 of about 0.1 millimeters (mm) to about 100 mm, and further including about 0.1 mm to about 10 mm. The lensing object 84 may also include a length 244 of about 0.1 mm to about 100 mm. Accordingly, the lensing object 84 may be formed to assist in the tool 60 working on the workpiece 54.

In various embodiments, the lensing object 84 may be formed of a selected material, such as a diamond or diamond like material. The lensing object 84 either alone or in combination with other portions of the tool 60 may be a tool tip or cutting portion. The lensing object 84 may be formed of a single crystal and/or a plurality of crystals or amorphous material formed or combined together. The lensing object may be formed as a naturally occurring diamond or other crystal material and/or a manufactured diamond. Nevertheless, the lensing object 84 may assist in directing and focusing energy transmitted through the bore 104 to a workpiece and/or drill or remove material from the workpiece 54.

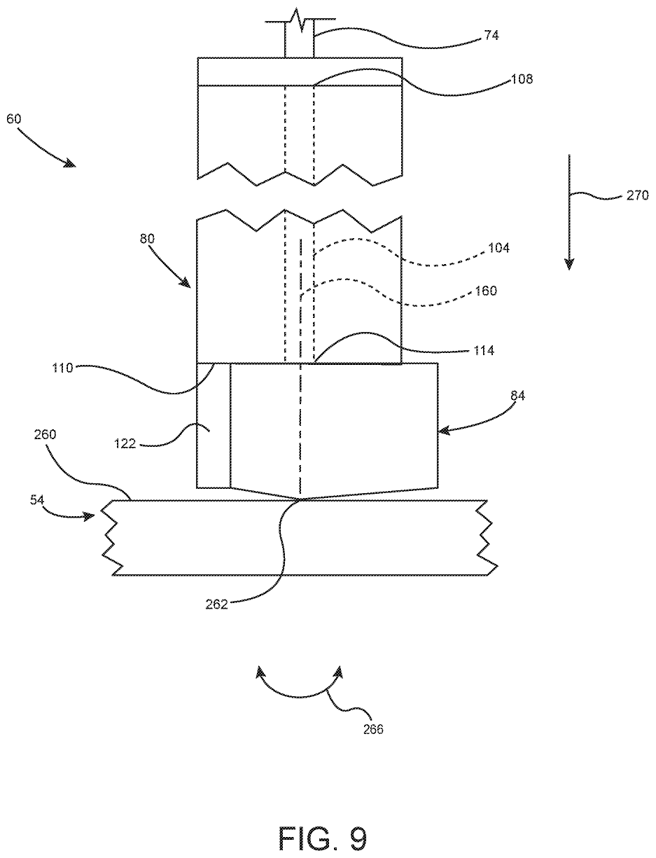

Returning reference to FIG. 1, and with additional reference to FIG. 2 and with additional reference to FIG. 9, the tool 60 may be used to work on the workpiece 54. Generally, the tool 60 may engage a selected surface, such as a work surface 260 with a working portion that may also be referred to as a working or cutting tip 262 of the lensing object 84. As discussed above, the working tip 262 may be formed by one or more points or apexes, such as the point or engaging surface 218 and 230, as discussed above. Further, as is understood by one generally skilled in the art, the tool 60 may rotate, such as around an axis generally in the direction of one or more of the double headed arrow 266. Accordingly, as is understood by one skilled in the art, various portions of the lensing object 84 may also act as a chip removing or evacuation surface, or other appropriate portion. Further, one or more coating (e.g. anti-reflective coatings) may be provided on one or more of the surfaces of the lensing object 84 to assist in effectively and efficiently directing the laser beam and energy relative to (e.g. directly to) the workpiece 54. Nevertheless, the tool 60 may generally be moved in the direction of arrow 270 to work on the workpiece 54, such as to form a hole or bore therein. The diameter of the bore may be formed within the workpiece 54 based upon the size of the lensing object 84 and/or other geometries.

In various embodiments, in operation, the drill system 20 has the laser transmission line 74 to transmit laser energy to the proximal end 108 of the bore 104. The laser energy, or any appropriate energy transmitted with and through the bore 104, may then transfer in the direction of the line or axis 160 to and through the lensing object 84. The lensing object 84 is configured to direct the energy to a selected area, such as one or more of the edges thereof, to assist in working the workpiece 54, such as the workpiece 54 formed of a material that is not transparent to the laser directed through the bore 104. The laser energy may then be focused on the work material 54, such as at the work surface 260 or below the upper or top surface, including at the work point 262. The lensing object 84, including the surfaces thereof, may then work on the workpiece 54, such as to drill to make a hole (blind or through hole) or mill or otherwise remove material from the workpiece 54. The lensing object 84, therefore, may operate as a cutting portion of the tool 60. Further, it is understood that more than one of the lensing objects may be provided with the tool 60, such as two or more formed as two or more cutting edges. Thus, the working end at the lensing object 84 may operate in a selected and/or efficient manner.

The directed and focused energy, such as the laser energy, may interact with the work surface or subsurface 260 of and/or the workpiece 54 to alter the physical properties of the workpiece 54 to assist in forming a selected working on the workpiece 54, such as forming a bore therein. In various embodiments, therefore, the workpiece 54 may be drilled while with the tool 60 that is augmented with the laser to heat and thermally soften the workpiece while minimizing cracking, chipping, and the like of the workpiece 54. In various embodiments, the workpiece 54 may be formed as one or more of and/or formed of one or more of semiconductors, ceramics, composites, ceramic matrix composites, rock, concrete, minerals, gems, etc.

The tool 60 may be used to work on the workpiece 54 with an appropriate driver, such as the driver 32. The tool 60 includes the lensing object 84 that may be used to focus and/or direct energy, such as a laser energy to interact with the workpiece 54. The interaction with the workpiece 54 may assist in ensuring an appropriate or selected work on the workpiece occurs, such as drilling or boring a hole with little or no chipping, cracking, or the like of the workpiece 54.

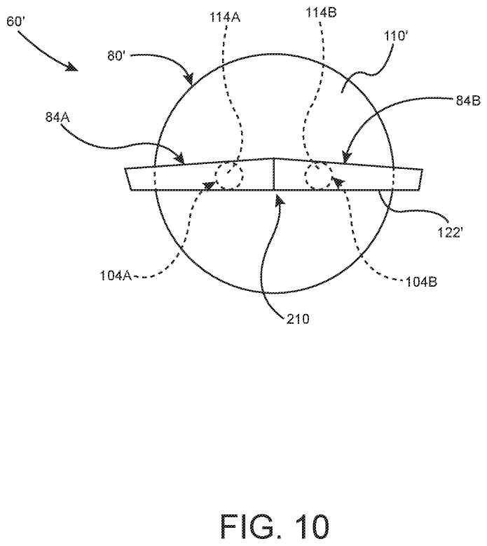

With continuing reference to the above, including FIG. 2, FIG. 3, and FIGS. 7A and 7B, the tool 60 may be formed in appropriate configurations, such as a tool 60′ illustrated in FIG. 10. The tool 60′ may include the shaft 80′, which may be substantially similar or identical to the shaft above. Further, the tool 60′ may include an end 110′ and a tool post 122′. The end 110′ and the post 122′ may be substantially identical to those discussed above. Nevertheless, the tool 60′ may include more than one bore formed through the shaft 80′, including a first bore 104a and a second bore 104b. Each of the two bores may extend from a first terminal end to a second terminal end 114a, 114b, respectively. Each of the bores 104a, 104b may include properties or features substantially identical to or similar to the bore 104, as discussed above. Accordingly, the bores 104a, 104b may include selected optical fibers and/or waveguide features and or have waveguide portions added therein. For example, a solid portion positioned therein, a coating positioned therein or on an interior wall, or a hollow core optical fiber or waveguide. The plurality of bores 104a, 104b may be formed in the shaft 80 to assist in directing a plurality of laser beams or energy to the end 110′. The beams may be formed from a split single beam. A plurality of beams may include a plurality of laser characteristics provided through the respective bores 104a, 104b.

With continuing reference to FIG. 10, the tool 60′ may further include a plurality of lensing objects, such as a first lensing object 84a and a second lensing object 84b. Each of the lensing objects 84a, 84b may be substantially identical or similar to the lensing object 84 discussed above. Accordingly, the lensing objects 84a, 84b, may be formed of appropriate or selected materials to transmit, reflect and/or refract the laser energy out a terminal end of the lensing objects 84a, 84b to assist in cutting, drilling, or working the workpiece 54. The plurality of the lensing objects 84a, 84b may be positioned on the shaft 80′. Each of the lensing objects 84a, 84b may assist in removing material form the workpiece 54, such as by forming cutting edges to assist in cutting or forming a selected hole within the workpiece 54.

As illustrated in FIG. 10, the two bores 104a, 104b may have the respective terminal ends 114a, 114b that are adjacent to the respective lensing objects 84a, 84b. Laser energy directed by the respective bores 104a, 104b may be directed to one of the selected lensing objects 84a, 84b. The lensing objects may be positioned on the shaft 80 in an appropriate manner, such as discussed above, and may join or contact at a contact point 210. In various embodiments, however, an air gap or space may be formed between the two lensing objects 84a, 84b such that they do not touch or contact with the contact point 210.

Thus, it is understood that the tool 60 may include more than one lensing object and/or more than one bore. A plurality of bores, such as two or more, may be formed in the shaft 80 to direct a plurality of beams to one or more lensing objects. It is further understood that a plurality of bores may be formed such that they are adjacent to one lensing object to direct a selected type or plurality of types of laser energy to a single lensing object.

The tool 60, 60′ may be formed to include or allow for one or more optical fibers or waveguide portions (e.g. bores) and/or lensing objects. Each of the lensing objects may include or define a cutting edge to assist in working on a workpiece, such as the workpiece 54. Thus the shaft 80, 80′ may further include one or more bores, such as the bore 104, 104a, 104b or in any appropriate selected number.

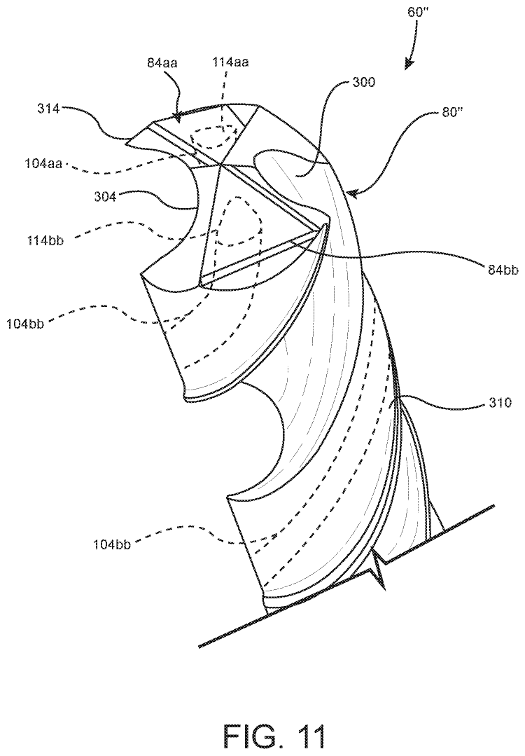

As discussed above, the tool 60 may be formed in a selected manner including the appropriate bores therethrough to assist as an optical fiber or a waveguide, either filled (e.g. solid or hollow core fiber), coated, or other appropriate waveguide. In various embodiments, with reference to FIG. 11, a tool 60″ is illustrated. The tool 60″ may be similar to the tool 60′, as illustrated in FIG. 10, and similar reference numerals include similar portions discussed above. The tool 60″, however, may include a shaft 80″ including one or more twisted flutes, such as a first twisted flute 300 and a second twisted flute 304. The twisted flutes 300, 304, may operate as flutes such as those in known twist drills. The flutes may operate to as chip clearance when drilling a hole. The shaft 80″ may further define one or more bores, such as a first bore 104aa and a second bore 104bb. The two bores 104aa, 104bb may extend through the shaft 80″ and substantially follow ridges 310 and 314 along the length of the shaft 80″ that define the flutes 300, 304. The bores 104aa, 104bb may both extend from a first or proximal end of the shaft 80″ to terminate at respective terminal ends 114aa, 114bb, similar to the terminal ends 114a, 114b of the tool 60′. Each of the terminal ends 114aa, 114bb may be positioned adjacent to respective lensing objects or optical portions 84aa, 84bb similar to the portions 84a, 84b of the tool 60′ discussed above. As discussed above, the lensing objects, according to various embodiments, are cutting portions formed of selected materials to have workpiece engaging edges or portions. It is understood, however, that only a single bore or more than two bores may be provided. Similarly, any appropriate number of the lensing objects 84 may be provided.

Accordingly, the tool 60″ may include a twist, including twist flutes 300, 304. One or more transmission bore portions 104aa, 104bb may extend through the shaft 80″, although in a twisted manner to reach the terminal ends 114aa, 114bb. Generally, the bores 104aa, 104bb may twist around a long axis of the shaft 80″, such as within the ridges 310, 314.

Thus, the tool 60″, according to various embodiments, may be provided with a twisted flute and/or a vertical flute, or any other appropriate flute configuration, as discussed above. The bores 104aa, 104bb may be formed as discussed above regarding the bores 104. The bores 104aa, 104bb may include various materials and/or coatings or configurations to act as light or waveguides from a proximal end of the shaft 80″ to the terminal ends 114aa, 114bb. Thus, the tool 60″ may be formed in an appropriate manner to act as a drill or other appropriate tool for working on the workpiece 54.

Further, any of the lensing objects 84aa, 84bb, according to various embodiments, can include selected configurations and/or coatings. For example, on the side or portion adjacent to the terminal ends 114 of the bores 104, the lensing objects 84 may include selective refractive and/or antireflective coatings to assist in directing and/or increasing efficiency of transfer of the laser energy to the lensing objects 84. Similarly, at the proximal terminal end, a lensing or beam splitting portion may include selected antireflective and/or refractive coatings to assist in directing and/or increasing efficiency of transfer of the laser energy into the respective bores 104. It is understood by one skilled in the art, the various embodiments may include selected features and configurations, as discussed above, in appropriate and selected combinations as understood by one skilled in the art. The above noted examples may be, therefore, combined in selected manners to achieve the herein disclosed system and methods.

The tool 60, according to various embodiments, may be engaged to the driver motor 32 in an appropriate manner, such as in a standard and/or commonly known chuck or collet. The shaft 80 that includes and/or defines the bore 104 allows for the transmission of the laser beam to the lensing portion 84, according to various embodiments. Thus, the shaft 80 may be engaged, for example, with a chuck or collet on an exterior of the shaft 80. The bore 104, therefore, is open to be accessed and/or irradiated with the selected energy, such as the laser beam. An external or separate transmission system to the lensing portion 84, according to various embodiments, outside of the shaft 80 is not required. The shaft 80, which may define an exterior diameter of the shaft 80 and/or tool 60, as discussed above, may be made to be engaged directly within a chuck or collet.

Further, one or more ferrules or reinforcing portions may be provided with the shaft 80. The ferrule may be provided or connected to assist in engaging in the selected shaft bore, collet or chuck. The ferrule, therefore, may be made of a selected material to assist in connection and/or fixing an optical fiber to the shaft 80 and the bore 104. In various embodiments, the ferrule may not likely engage the collet or chuck. The ferrule may be located at appropriate positions, such as at the ends of optical fiber (or other portions placed in the bore 104) and engages the inner diameter of the bore 104 of the shaft 80. The ferrule may generally position and secure the fiber to the bore 104. The ferrule may be useful when the fiber outer diameter is less than the inner diameter of the bore 104. The ferrule may be pressed into the bore, or adhered with adhesives, etc.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A tool assembly for working a workpiece, comprising:
a member extending from a first end to a second end; and
an energy transmission portion formed within the member extending from the first end configured to transmit a selected energy toward the second end; and
a single lensing object configured to transmit the selected energy to the workpiece and cut the workpiece, wherein the single lensing object includes a workpiece contacting surface including a cutting portion to engage the workpiece;
wherein the selected energy transmitted to the first end is transmitted toward the second end through the energy transmission portion and to the single lensing object.

2. The assembly of claim 1,
wherein the single lensing object is configured to be fixed near the second end of the member.

3. The assembly of claim 1, wherein the member and the energy transmission portion are at least one of co-axial, non-coaxial, or the energy transmission portion is twisted around an axis of the member.

4. The assembly of claim 1, wherein the member defines a bore between the first end and the second end;
wherein the bore defines the energy transmission portion.

5. The assembly of claim 1, wherein the member defines a bore between the first end and the second end;
wherein the energy transmission portion includes at least one of a fiber optic member, a waveguide, or a hollow core optical fiber positioned in the bore.

6. The assembly of claim 1, wherein the member defines a bore between the first end and the second end;
wherein the energy transmission portion includes a coating on an inner wall of the bore.

7. The assembly of claim 1, wherein the single lensing object is configured to direct energy to the workpiece and work the workpiece.

8. The assembly of claim 7, wherein the single lensing object is a hard and optically transparent tool material.

9. The assembly of claim 1, wherein the energy transmission portion includes a plurality of bores defined by the member.

10. (canceled)

11. The assembly of claim 1, further comprising:
an entry optical element, wherein the entry optical element is positioned near the first end to direct a laser beam to the energy transmission portion.

12. The assembly of claim 11, wherein the energy transmission portion includes a first energy transmission portion and a second energy transmission portion;
wherein the entry optical element is a beam splitter.

13. A working assembly for working a workpiece, comprising:
a member extending from a first end to a second end;
an energy transmission portion formed within the member extending from an inlet end to an outlet end to transmit an energy through the member;
a transparent object configured to be fixed to the member near the outlet end and transparent to the energy transmitted through the energy transmission portion; and
wherein a laser energy is emitted from a laser emission system and transmitted to the inlet end and then transmitted toward the outlet end and to the transparent object through the energy transmission portion.

14. The assembly of claim 13, wherein the member and the energy transmission portion are co-axial.

15. The assembly of claim 13, wherein the energy transmission portion is a bore defined by the member between the first end and the second end;
wherein energy transmission portion includes least one of the bore, a fiber optic member positioned in the bore, a coating on an inner wall of the bore, or combinations thereof.

16. The assembly of claim 13, wherein the transparent object is a diamond.

17. A method of forming a tool assembly for working a workpiece, comprising:
forming an energy transmission portion within a member extending from a first end to a second end of the member; and
positioning at the first end of the member a single lensing object operable to (i) transmit a selected energy to the workpiece and (ii) cut the workpiece;
wherein the selected energy that is transmitted to the second end is (i) transmitted to the first end through the energy transmission portion and (ii) through the single lensing object;
wherein the single lensing object of the tool assembly is configured to cut the workpiece.

18. The method of claim 17, wherein forming the energy transmission portion, further comprises at least one of forming a bore within the member, positioning a fiber optic member within in a bore formed in the member, coating an inner wall of a bore formed within the member, a hollow core fiber optic, forming a waveguide with the bore, or combinations thereof.

19. The method of claim 17, wherein forming the energy transmission portion includes forming a plurality of energy transmission portions within the member.

20. The method of claim 17, wherein forming the energy transmission portion includes forming at least one bore twisting around an axis of the member.

21. The method of claim 17, further comprising:
at least one of:
fixing the single lensing object to the member adjacent to the energy transmission portion; or
fixing an entry optical element to the member at the first end;
wherein fixing the single lensing object to the member includes fixing the single lensing object to the member at the second end.

22. The assembly of claim 13, further comprising:
a laser emission system.

23. The assembly of claim 1, wherein the cutting portion to engage the workpiece that is the only portion to cut the workpiece.
